(19) United States
(12) Patent Application Publication
(10) Pub. No.: US 2025/0105538 A1
(43) Pub. Date: Mar. 27, 2025

(54) INSERTION SLOT CONNECTOR AND CONNECTOR ASSEMBLY

(71) Applicant: LOTES CO., LTD, Keelung (TW)

(72) Inventors: Chien-Chih Ho, Keelung (TW); Jian-Wen Zhang, Keelung (TW); Ping-Han Tsou, Keelung (TW); Li-Chien Wan, Keelung (TW)

(21) Appl. No.: 18/818,718

(22) Filed: Aug. 29, 2024

(30) Foreign Application Priority Data
Sep. 27, 2023 (CN) 202322637651.9

(51) Int. Cl. H01R 12/73; H01R 12/70; H01R 13/422; H01R 13/629

(52) U.S. Cl. CPC H01R 12/737; H01R 12/707; H01R 13/422; H01R 13/629

(57) ABSTRACT

An insertion slot connector and a connector assembly. The insertion slot connector includes an insulating body and multiple conductive terminals. The insulating body includes two side walls, a bottom wall and an insertion slot. The insulating body has a mating surface and a mounting surface provided opposite to each other. The insertion slot runs through the mating surface. Each conductive terminal includes a base, an elastic arm extending from the base toward the mating surface and turns back to extend toward the bottom wall, a contact portion provided at a tail end of the elastic arm and a soldering portion. A distance between the insertion slot and the soldering surface of the soldering portion in the insertion direction is not greater than 0.70 mm. The connector assembly includes a circuit board and at least one insertion slot connector and at least one card edge connector alternately mounted thereon.

### CROSS-REFERENCE TO RELATED PATENT APPLICATION

This non-provisional application claims priority to and the benefit of, pursuant to 35 U.S.C. § 119 (a), patent application Serial No. CN202322637651.9 filed in China on Sep. 27, 2023. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an insertion slot connector and a connector assembly including the insertion slot connector, and particularly to an insertion slot connector and a connector assembly reducing the antenna effect.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In the current computer system, a circuit board may be simultaneously provided with a plurality of card edge connectors side-by-side. The structure of each card edge connector generally includes an insulating body and a plurality of conductive terminals, and each card edge connector is used for inserting an electronic card therein. However, in the practical usage process, there may be a case where some of the card edge connectors are left vacant without cards being inserted therein, and the conductive terminals of the vacant card edge connectors may generate the antenna effect, thereby generating an electromagnetic interference to the nearby card edge connectors with cards being inserted therein.

To reduce the electromagnetic interference generated by the vacant card edge connectors to the card edge connectors with cards being inserted therein, a card edge connector of a current computer system is provided as a bottom connector and a top connector that may be separated from each other. When the card edge connector is at a vacant state, only the bottom connector is connected to the computer system, and it is required to remove the top connector. A length of the conductive terminals of the bottom connector is between 2.25 mm and 2.75 mm, which is far less than the length of the conductive terminals of the regular card edge connector of about 6 mm, thereby reducing the electromagnetic interference generated by the vacant card edge connectors to the card edge connectors in operation with cards being inserted therein.

However, by providing the vacant card edge connector as two portions separated from each other, when a user inserts an electronic card into a vacant card edge connector, the user must connect the top connector to the bottom connector, and then insert the electronic card into the top connector, thus resulting in a complex structure, with many steps of the usage process and usage inconvenience.

Therefore, a heretofore unaddressed need to design a new card edge connector exists in the art to address the aforementioned deficiencies and inadequacies.

### SUMMARY

The present invention is directed to an insertion slot connector reducing the antenna effect and a connector assembly including the insertion slot connector.

To achieve the foregoing objective, the present invention adopts the following technical solutions.

An insertion slot connector includes: an insulating body, comprising two side walls extending along a longitudinal direction and opposite to each other in a lateral direction and a bottom wall connecting the two side walls, and defining an insertion slot surroundingly formed by the two side walls and the bottom wall, wherein the insulating body has a mating surface and a mounting surface provided opposite to each other along an insertion direction, the insertion slot runs through the mating surface along the insertion direction, and each two of the longitudinal direction, the lateral direction and the insertion direction are perpendicular to each other; and a plurality of conductive terminals, wherein each of the conductive terminals comprises a base, an elastic arm and a soldering portion, the base is provided on the insulating body, the elastic arm extends from one end of the base adjacent to the mating surface toward the mating surface and turns back to extend toward the bottom wall, the clastic arm has a free end and is provided with a contact portion on the free end, the contact portion is exposed to the insertion slot in the lateral direction, the soldering portion bends and extends from one end of the base adjacent to the mounting surface, the soldering portion has a soldering surface, and the soldering surface is exposed to the mounting surface along the insertion direction; wherein a distance between a slot bottom of the insertion slot and the soldering surface in the insertion direction is not greater than 0.70 mm.

In certain embodiments, an expansion length of each of the conductive terminals from the soldering portion to the contact portion is between 4.17 and 4.23 mm.

In certain embodiments, a distance between the contact portion and the slot bottom of the insertion slot is not greater than 1.43 mm.

In certain embodiments, each of the conductive terminals is formed by bending a metal plate, and the contact portion is provided with at least one chamfer structure along at least one of a thickness direction and a width direction of the metal plate.

In certain embodiments, the insertion slot connector further includes an ejector. The insulating body comprises at least one tower portion located on at least one end of the insertion slot in the longitudinal direction, the ejector is rotatably mounted on the tower portion and switched between a closed position and an open position, the ejector is configured to lock an electronic card inserted into the insertion slot at the closed position, the ejector unlocks the electronic card at the open position, the ejector comprises an insulation body and a metal reinforcing member engaged in the insulation body, the metal reinforcing member is provided with at least one through hole, the through hole runs through the metal reinforcing member along the lateral direction, the through hole is provided for the insulation body to be engaged therein, the through hole has a length and a width, and when the ejector is located at the closed position, the length is provided obliquely relative to the insertion direction.

In certain embodiments, the insulating body has a plurality of terminal slots, the conductive terminals are correspondingly accommodated in the terminal slots, the terminal slots and the insertion slot are in communication with each other in the lateral direction, each of the terminal slots has a step surface located farther away from the insertion slot than the base in the lateral direction, the step surface is parallel to the slot bottom of the insertion slot, in the insertion direction, the step surface is located closer to the mating surface than the slot bottom of the insertion slot, and a distance between the step surface and the slot bottom of the insertion slot in the insertion direction is not greater than one half of a height of the bottom wall in the insertion direction.

In certain embodiments, the insulating body has a plurality of terminal slots, the conductive terminals are correspondingly accommodated in the terminal slots, the terminal slots and the insertion slot are in communication with each other in the lateral direction, the base is provided with a fixing portion, the fixing portion interferes with a corresponding one of the terminal slots, in the insertion direction, the fixing portion is located closer to the mounting surface than the slot bottom of the insertion slot, and a distance between the fixing portion and the slot bottom of the insertion slot is not greater than one third of a height of the bottom wall in the insertion direction.

In certain embodiments, the insulating body has a plurality of terminal slots, the conductive terminals are correspondingly accommodated in the terminal slots, each of the terminal slots has a matching slot wall for the base to abut against the matching slot wall in the lateral direction, each of the conductive terminals is formed by bending a metal plate, the base has two plate surfaces opposite to each other in a thickness direction of the metal plate, the two plate surfaces are provided opposite to each other along the lateral direction, the base is protrudingly provided with at least one fixing portion on one of the plate surfaces located farther away from the insertion slot in the lateral direction, the fixing portion abuts against the matching slot wall in the lateral direction, the base portion has a movable portion located closer to the mating surface than the fixing portion in the insertion direction, the movable portion is connected to the elastic arm, and a gap exists between the movable portion and the matching slot wall due to existence of the fixing portion for the movable portion to deviate.

In certain embodiments, a length of the fixing portion protruding in the lateral direction relative to a corresponding one of the plate surfaces is not less than 0.05 mm.

In certain embodiments, the insulating body has a plurality of terminal slots, the conductive terminals are correspondingly accommodated in the terminal slots, each of the terminal slots has at least one matching slot wall for the base to abut against the matching slot wall in the lateral direction, the matching slot wall is a flat structure extending the insertion direction and the longitudinal direction, the matching slot wall is located at one side of the base away from the insertion slot in the lateral direction, the base has a movable portion connected to the elastic arm, each of the terminal slots further has a position limiting surface connected to the matching slot wall and configured to limit the movable portion from excessive rotating, and the position limiting surface is formed by extending from the matching slot wall toward one side away from the insertion slot in the lateral direction and toward the mating surface in the insertion direction.

In certain embodiments, a gap between the position limiting surface and a corresponding one of the conductive terminals gradually becomes larger along a direction from the mounting surface toward the mating surface.

Compared to the related art, the insertion slot connector according to certain embodiments of the present invention has the following beneficial effects:

By extending the elastic arm of each conductive terminal toward the mating surface and turning back to extend toward the bottom wall, the contact portion is provided at the free end of the elastic arm, and the distance between the slot bottom of the insertion slot and the soldering surface in the insertion direction is not greater than 0.70 mm. Thus, on the premise of ensuring the mechanical characteristics of the conductive terminals, the length of each conductive terminal is reduced, and the antenna effect is reduced.

A connector assembly includes: a circuit board, having a first surface and a second surface provided opposite to each other in an insertion direction; and at least one insertion slot connector and at least one card edge connector, wherein the insertion slot connector and the card edge connector are alternately mounted on the circuit board along a lateral direction, and the lateral direction is perpendicular to the insertion direction; wherein the insertion slot connector comprises an insulating body and a plurality of conductive terminals provided on the insulating body, the insulating body comprises two side walls extending along a longitudinal direction and opposite to each other in the lateral direction and a bottom wall connecting the two side walls, and defines an insertion slot surroundingly formed by the two side walls and the bottom wall, the longitudinal direction is perpendicular to the lateral direction and the insertion direction, the insulating body has a mating surface and a mounting surface provided opposite to each other along the insertion direction, the mounting surface is provided to face the first surface in the insertion direction, the insertion slot runs through the mating surface along the insertion direction, each of the conductive terminals comprises a base, an elastic arm and a soldering portion, the base is provided on the insulating body, the elastic arm extends from one end of the base adjacent to the mating surface toward the mating surface and turns back to extend toward the bottom wall, the elastic arm has a free end and is provided with a contact portion on the free end, the contact portion is exposed to the insertion slot in the lateral direction, and the soldering portion is exposed to the mounting surface and is soldered to the circuit board; wherein the card edge connector comprises an insulating seat and a plurality of mating terminals accommodated in the insulating seat, the insulating seat comprises two side portions extending along the longitudinal direction and opposite to each other in the lateral direction and a bottom portion connecting the two side portions, and defines an engaging slot surroundingly formed by the two side portions and the bottom portion, the insulating seat has an insertion surface and an assembly surface provided opposite to each other along the insertion direction, the assembly surface is provided to face the first surface, the engaging slot runs through the insertion surface along the insertion direction, each of the mating terminals comprises a body portion, a spring arm and a soldering leg, the body portion is provided on the insulating seat, the spring arm is formed by extending from the body portion and has a conductive portion, the conductive portion is exposed to the insertion slot in the lateral direction, and the soldering leg is exposed to the mounting surface and is soldered to the circuit board; wherein in the insertion direction, a distance between the insertion slot and the first surface is less than a distance between the engaging slot and the first surface, a distance between the contact portion and the first surface is less than a distance between the conductive portion and the first surface, and a distance between the contact portion and a slot bottom of the insertion slot is less than a distance between the conductive portion and a slot bottom of the engaging slot.

In certain embodiments, a distance between the insertion slot and the first surface in the insertion direction is not greater than 0.70 mm.

In certain embodiments, an expansion length of each of the conductive terminals from the soldering portion to the contact portion is not greater than an expansion length of each of the mating terminals from the soldering leg to a tail end of the spring arm.

In certain embodiments, an expansion length of each of the conductive terminals from the soldering portion to the contact portion is between 4.17 and 4.23 mm.

In certain embodiments, each of the conductive terminals is formed by bending a metal plate, the contact portion is provided with at least one chamfer structure along at least one of a thickness direction and a width direction of the metal plate, and the chamfer structure of the contact portion formed in the thickness direction is exposed to the insertion slot in the lateral direction to be in contact with an electronic card inserted into the insertion slot.

Compared to the related art, the connector assembly according to certain embodiments of the present invention has the following beneficial effects:

The distance between the insertion slot and the first surface is less than the distance between the engaging slot and the first surface, the distance between the contact portion and the first surface is less than the distance between the conductive portion and the first surface, and the distance between the contact portion and a slot bottom of the insertion slot is less than the distance between the conductive portion and a slot bottom of the engaging slot. Thus, the overall length of each conductive terminal is less than the overall length of each mating terminal, and when the card edge connector has an electronic card being inserted therein and the insertion slot connector is vacant, the overall length of each conductive terminal is reduced, thus reducing the electromagnetic interference caused by the antenna effect of the vacant insertion slot connector to the adjacent card edge connector in operation.

A connector assembly includes: a circuit board; and at least one insertion slot connector and at least one card edge connector, wherein the insertion slot connector and the card edge connector are alternately mounted on the circuit board along a lateral direction; wherein the insertion slot connector has an insertion slot, the card edge connector has an engaging slot, the insertion slot and the engaging slot are configured for insertion of an electronic card of a same type along an insertion direction, the insertion direction is perpendicular to the lateral direction, and in the insertion direction, a distance between a slot bottom of the insertion slot and the circuit board is less than a distance between a slot bottom of the engaging slot and the circuit board.

In certain embodiments, the insertion slot connector comprises an insulating body and a plurality of conductive terminals provided on the insulating body, the insulating body has a mating surface and a mounting surface provided opposite to each other along the insertion direction and the insertion slot formed by recessing from the mating surface toward the mounting surface, and the mounting surface is provided to face the circuit board; and the card edge connector comprises an insulating seat and a plurality of mating terminals provided on the insulating seat, the insulating seat has an mating surface and an assembly surface provided opposite to each other along the insertion direction and the engaging slot formed by recessing from the mating surface toward the assembly surface, the assembly surface is provided to face the circuit board, and in the insertion direction, a distance between the mating surface and the circuit board is less than a distance between the insertion surface and the circuit board.

In certain embodiments, the insertion slot connector further comprises an ejector, the ejector comprises an insulating main body and a metal reinforcing member provided on the insulating main body, the ejector has a card ejecting portion, the metal reinforcing member partially extends to the card ejecting portion, the ejector is rotatably mounted on one end of the insulating body in a longitudinal direction, the longitudinal direction is perpendicular to the insertion direction and the lateral direction, the ejector is switched between a closed position and an open position, the ejector is configured to lock the electronic card inserted into the insertion slot at the closed position, and when the ejector is at the open position, the card ejecting portion abuts against the electronic card inserted into the insertion slot; and the card edge connector further comprises a card locking member, the card locking member has a card pushing portion, the card locking member is rotatably mounted on at least one end of the insulating seat in the longitudinal direction, the card locking member is switched between a closed position and an open position, the card locking member is configured to lock the electronic card inserted into the engaging slot at the closed position, when the card locking member is at the open position, the card pushing portion abuts against the electronic card inserted into the insertion slot, the card ejecting portion has a first abutting surface configured to abut against the electronic card, the card pushing portion has a second abutting surface configured to abut against the electronic card, and when the ejector is at the closed position and the card locking member is at the closed position, a distance between the first abutting surface and the circuit board is less than a distance between the second abutting surface and the circuit board.

In certain embodiments, each of the conductive terminals is an integral structure and comprises a base and an elastic arm, the clastic arm extends from one end of the base, and the clastic arm is provided with a contact portion exposed to the insertion slot; and each of the mating terminals comprises a body portion and a spring arm, the spring arm is formed by extending from the body portion and has a conductive portion exposed to the engaging slot, and in the insertion direction, a distance between the contact portion and the circuit board is less than a distance between the conductive portion and the circuit board.

In certain embodiments, the conductive terminals are formed by punching a metal plate, the mating terminals are formed by punching a different metal plate, and a thickness of the metal plate forming the conductive terminals is thinner than a thickness of the metal plate forming the mating terminals.

Compared to the related art, the connector assembly according to certain embodiments of the present invention has the following beneficial effects:

The insertion slot and the engaging slot are used for insertion of the electronic card of a same type, and the distance between the slot bottom of the insertion slot and the circuit board is less than the distance between the slot bottom of the engaging slot and the circuit board. Thus, for the insertion slot connector relative to the card edge connector, a conductive path from the electronic card to the circuit board may be correspondingly shortened, thereby reducing the electromagnetic interference caused by the antenna effect of the vacant insertion slot connector to the adjacent card edge connector in operation.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective assembly view of a connector assembly according to a first embodiment of the present invention.

FIG. 2 is a partial sectional view of FIG. 1 along a plane parallel to the X-Z plane.

FIG. 3 is a partial sectional view of FIG. 2 without inserting an electronic card.

FIG. 4 is a perspective exploded view of an insertion slot connector in FIG. 1.

FIG. 5 is a perspective view of a conductive terminal in FIG. 4.

FIG. 6 is an expanded schematic view of a conductive terminal and a mating terminal in FIG. 3.

FIG. 7 is a perspective exploded view of an ejector in FIG. 4.

FIG. 8 is a partial sectional view of FIG. 1 after ladder-sectioning the insertion slot connector along two planes parallel to the Y-Z plane.

FIG. 9 is a partial sectional view of an insertion slot connector and a circuit board of a connector assembly along a plane parallel to the X-Z plane according to a second embodiment of the present invention.

FIG. 10 is a schematic view of the insertion slot connector in FIG. 9 after inserting an electronic card therein.

FIG. 11 is an enlarged view of a region A in FIG. 9.

FIG. 12 is a partial sectional view of an insertion slot connector and a circuit board of a connector assembly along a plane parallel to the X-Z plane according to a third embodiment of the present invention.

FIG. 13 is a schematic view of the insertion slot connector in FIG. 12 after inserting an electronic card therein.

FIG. 14 is an enlarged view of a region B in FIG. 12.

FIG. 15 is an enlarged view of a region C in FIG. 13.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

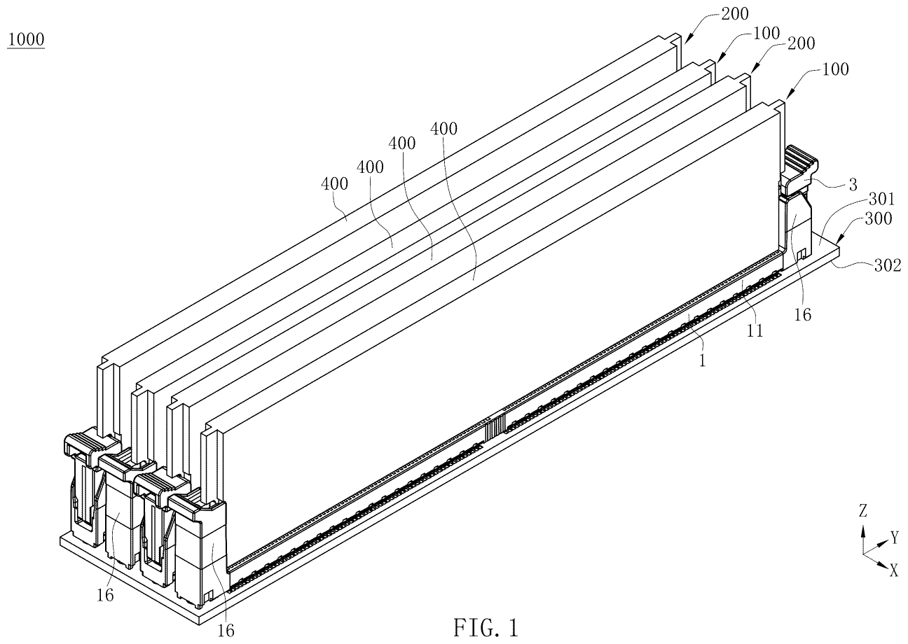

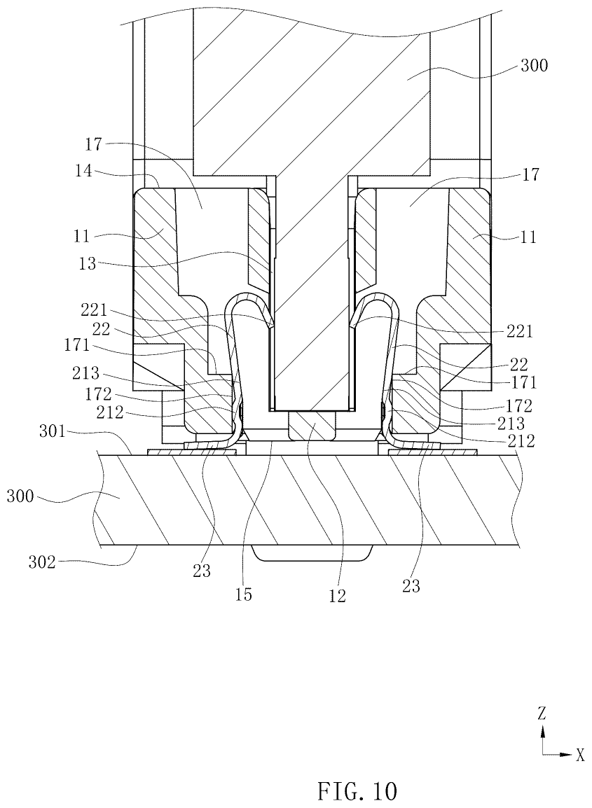

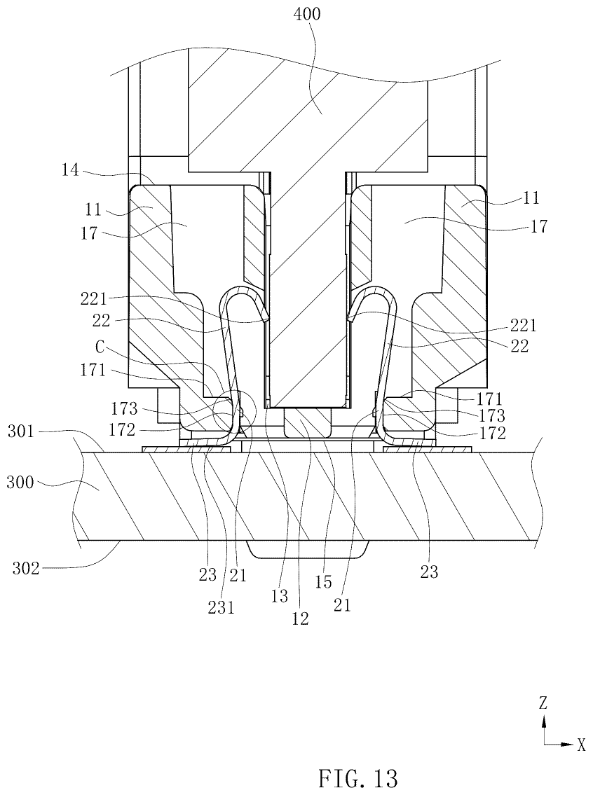

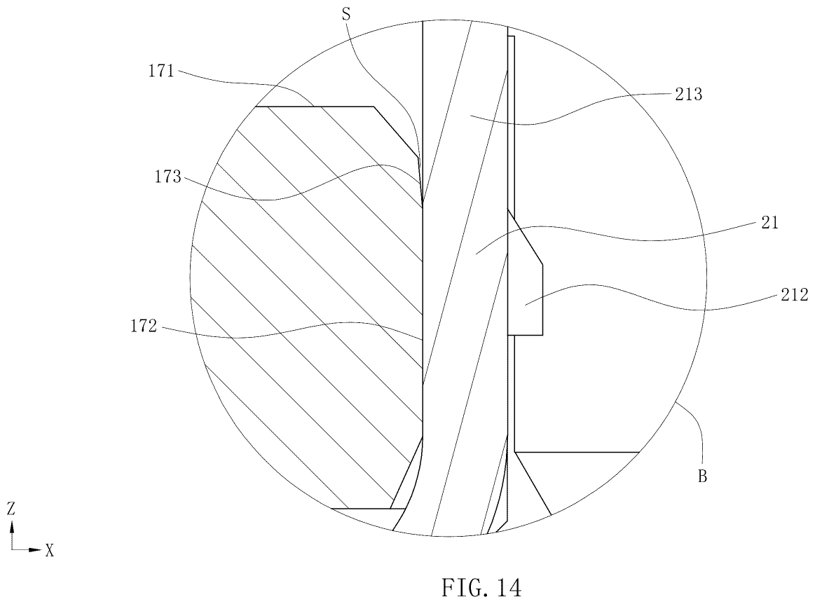

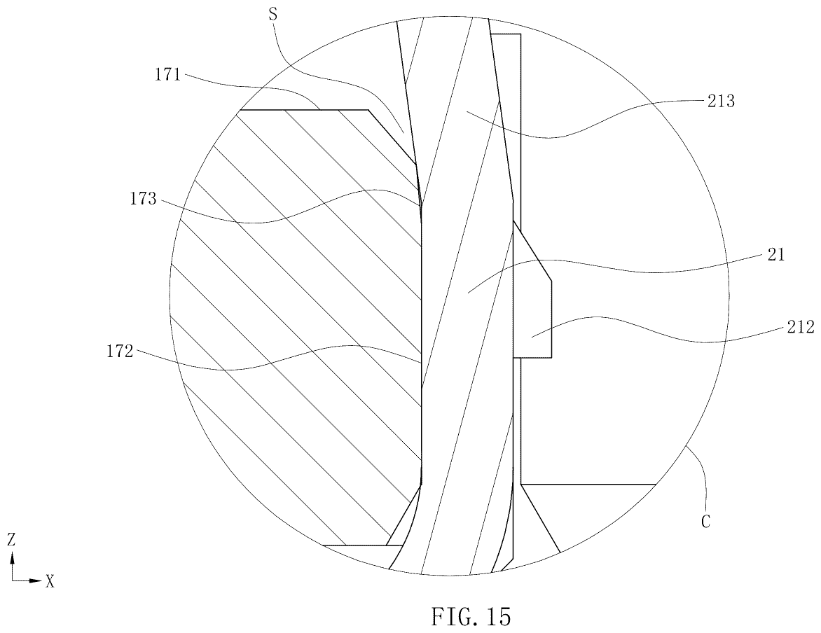

The description will be made as to the embodiments of the present invention in conjunction with the accompanying drawings in FIGS. 1-15. In accordance with the purposes of this invention, as embodied and broadly described herein, this invention, in one aspect, relates to an insertion slot connector and a connector assembly.

For ease of understanding, a lateral direction is defined as the X-axis, a longitudinal direction is defined as the Y-axis, an insertion direction is defined as the Z-axis, and any two of the three directions are perpendicular to each other.

FIG. 1 to FIG. 8 show schematic views of a connector assembly 1000 according to a first embodiment of the present invention. The connector assembly 1000 includes a plurality of insertion slot connectors 100, a plurality of card edge connectors 200 and a circuit board 300. The circuit board 300 includes a first surface 301 and a second surface 302 opposite to each other. The insertion slot connectors 100 and the card edge connectors 200 are mounted on the first surface 301. A plurality of electronic cards 400 are inserted into the insertion slot connectors 100 and the card edge connectors 200, and are further electrically connected to the circuit board 300. In the present embodiment, a same electronic card 400 may be inserted into an insertion slot connector 100, and may be inserted into a card edge connector 200.

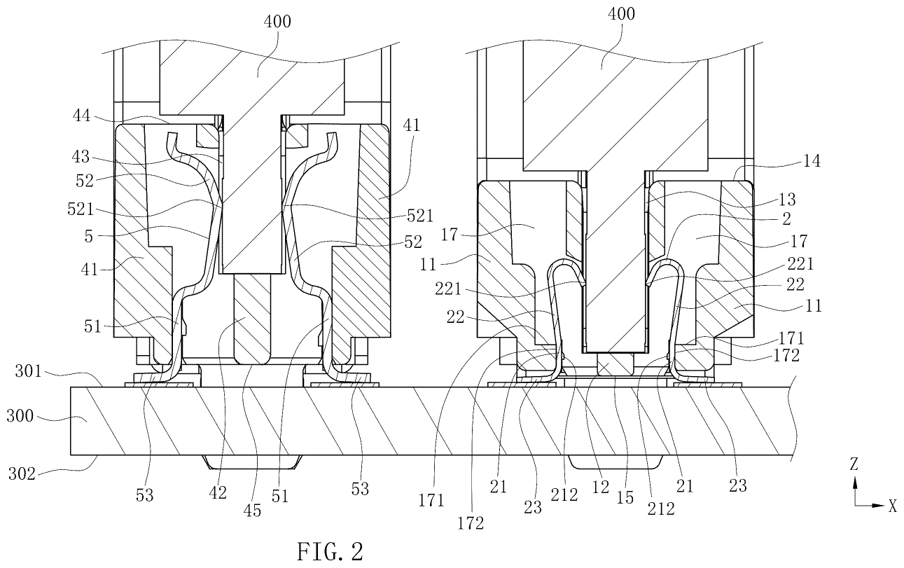

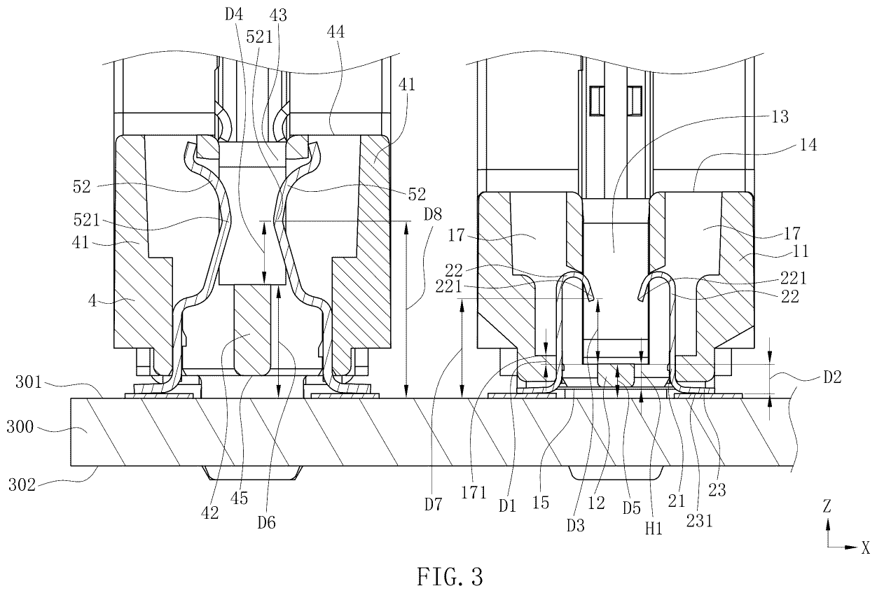

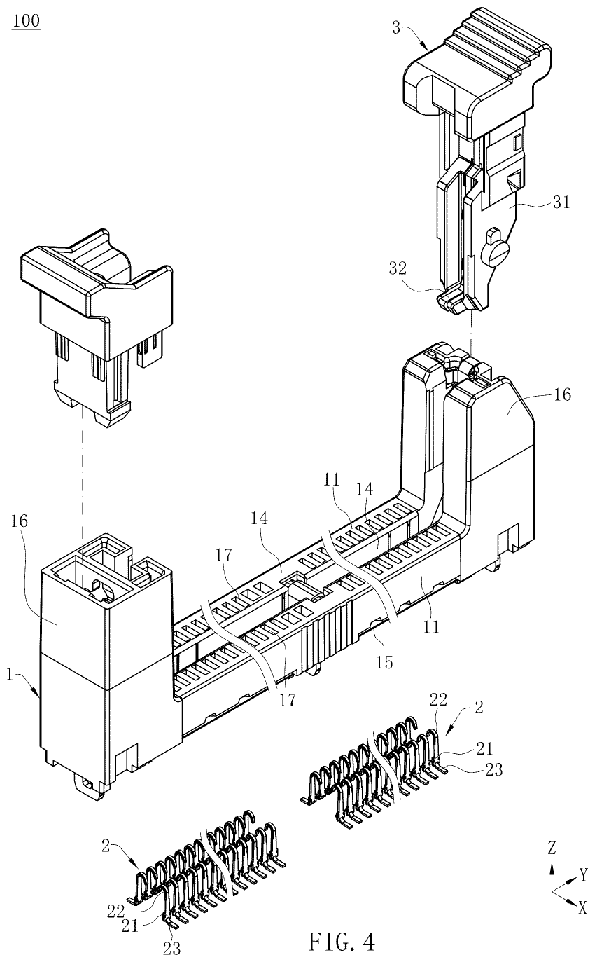

As shown in FIG. 2, FIG. 3 and FIG. 4, the insertion slot connector 100 includes an insulating body 1, a plurality of conductive terminals 2 provided on the insulating body 1 and an ejector 3. The insulating body 1 includes two side walls 11 extending along the longitudinal direction and opposite to each other in the lateral direction, a bottom wall 12 connecting the two side walls 11, an insertion slot 13 surroundingly formed by the two side walls 11 and the bottom wall 12, and two tower portions 16 located at two ends of the insertion slot 13 in the longitudinal direction. A height of the bottom wall 12 in the insertion direction is defined as H1. The insulating body 1 has a mating surface 14 and a mounting surface 15 provided opposite to each other along the insertion direction. The mounting surface 15 is provided to face the first surface 301. The insertion slot 13 runs through the mating surface 14 along the insertion direction. The height H1 of the bottom wall 12 in the insertion direction is a distance between a slot bottom of the insertion slot 13 and the mounting surface 15. In the present embodiment, H1 is 0.50 mm. Thus, on the premise that the strength of the insulating body 1 satisfies the usage requirement, the overall height of the insertion slot connector 100 in the insertion direction may be reduced, allowing each conductive terminal 2 to follow and reduce its height. The insulating body 1 has a plurality of terminal slots 17, and the terminal slots 17 are distributed on the two side walls 11. Each terminal slot 17 runs through the mating surface 14 and the mounting surface 15 in the insertion direction, and each terminal slot 17 is in communication with the insertion slot 13 in the lateral direction. In other embodiments, the terminal slots 17 may be provided only on one of the two side walls 11, and two ejectors 3 may be provided at two ends of the insulating body 1 along the longitudinal direction.

As shown in FIG. 2 and FIG. 3, each terminal slot 17 has a step surface 171 and a matching slot wall 172 connected to the step surface 171 and extending toward the mounting surface 15 along the insertion direction. The step surface 171 is parallel to the slot bottom of the insertion slot 13. In the insertion direction, the step surface 171 is located closer to the mating surface 14 than the slot bottom of the insertion slot 13, and a distance D1 between the step surface 171 and the slot bottom of the insertion slot 13 in the insertion direction is not greater than one half of the height H1 of the bottom wall 12 in the insertion direction.

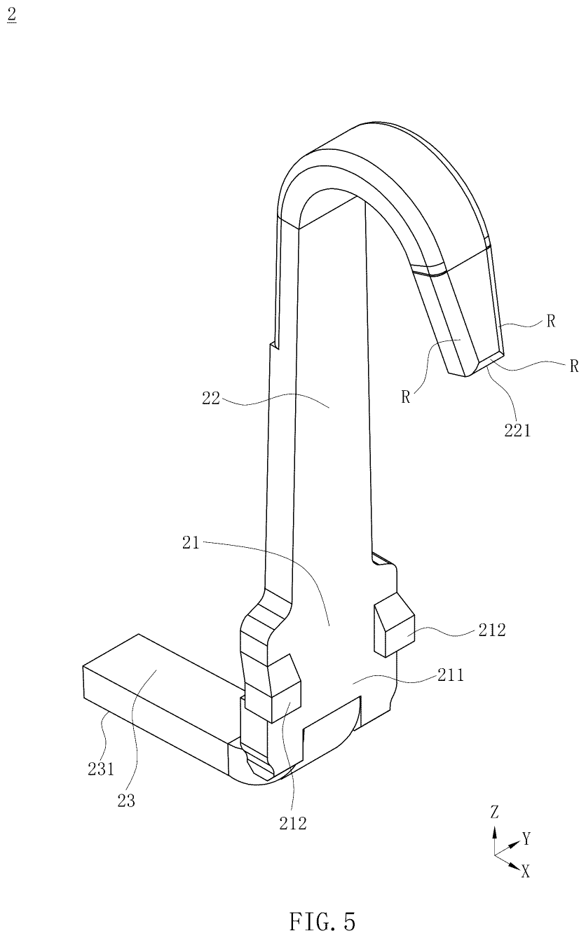

As shown in FIG. 5, each conductive terminal 2 is an integral structure formed by bending a metal plate, and includes a base 21, an elastic arm 22 and a soldering portion 23.

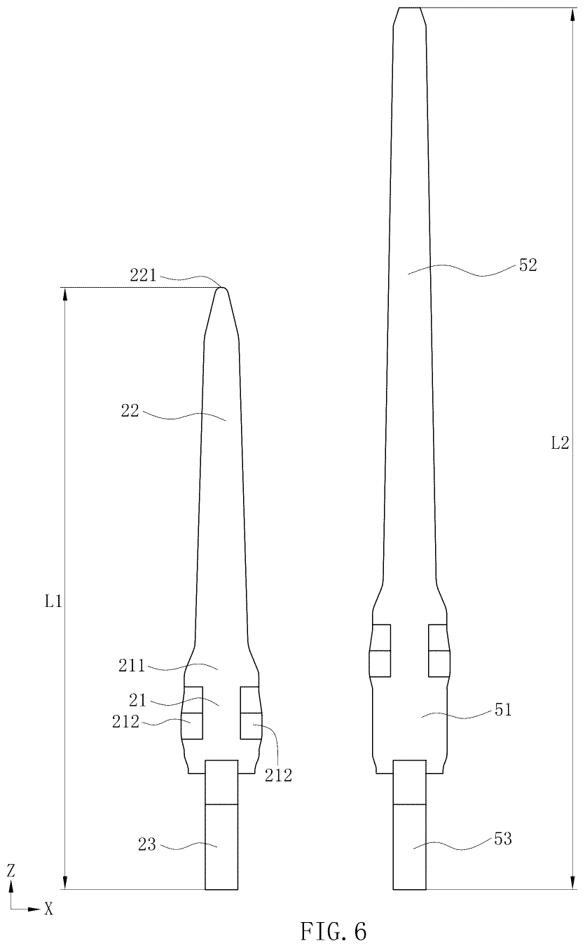

As shown in FIG. 3, FIG. 5 and FIG. 6, the base 21 has two plate surfaces 211 opposite to each other in a thickness direction of the metal plate. The thickness direction of the base 21 is consistent with the lateral direction. That is, the two plate surfaces 211 are provided opposite to each other in the lateral direction. The step surface 171 and the matching slot wall 172 are located farther away from one side of the insertion slot 13 than the base 21 in the lateral direction. The matching slot wall 172 provides support for one of the plate surfaces 211 of the base 21 away from the insertion slot 13. The base 21 is protrudingly provided with two fixing portions 212 at the two sides of a width direction of the metal plate and toward the insertion slot 13 in the lateral direction. The width direction is consistent with the longitudinal direction, and each fixing portion 212 is interference-fixed in a corresponding terminal slot 17. In other embodiments, the fixing portions 212 may be formed by extending continuously along the width direction from the two sides of the base 21 in the width direction, and a distance between each fixing portion 212 and the slot bottom of the insertion slot 13 is not less than one third of the height H1 of the bottom wall 21 in the insertion direction.

As shown in FIG. 2, FIG. 3 and FIG. 5, the elastic arm 22 extends from one end of the base 21 adjacent to the mating surface 14 toward the mating surface 14 substantially along the insertion direction and turns back to extend toward the bottom wall 12. Specifically, the elastic arm 22 extends straightly along the insertion direction. In other embodiments, the elastic arm 22 may extend obliquely along the insertion direction. The elastic arm 22 has a free end and is provided with a contact portion 221 on the free end, and the contact portion 221 is exposed to the insertion slot 13 in the lateral direction. A tail end of the contact portion 221 is provided with chamfer structures R along a thickness direction and a width direction of the metal plate. Specifically, a round chamfer structure is provided in the width direction, and a round chamfer structure is provided in the thickness direction. By providing the chamfer structure R in the width direction, an electrical connection region between the contact portion 221 and the electronic card 400 is more concentrated, and the contact effect is better. By providing the chamfer structure R in the thickness direction, the electronic card 400 may be prevented from scratching. In other embodiments, the tail end of the contact portion 221 may be provided with a chamfer structure R along only one of the thickness direction and the width direction of the metal plate, and the chamfer structure may be a round chamfer structure, or may be a right-angled chamfer structure.

As shown in FIG. 2, FIG. 3 and FIG. 5, the soldering portion 23 bends and extends from one end of the base 21 adjacent to the mounting surface 15 along the lateral direction. The soldering portion 23 is exposed to the mounting surface 15 along the insertion direction. The soldering portion 23 has a soldering surface 231 facing the circuit board 300. A distance D2 between the slot bottom of the insertion slot 13 and the soldering surface 231 in the insertion direction is not greater than 0.70 mm. In the present embodiment, the distance D2 between the slot bottom of the insertion slot 13 and the soldering surface 231 in the insertion direction is 0.65 mm.

As shown in FIG. 2, FIG. 3 and FIG. 6, an expansion length L1 of each conductive terminal 2 from the soldering portion 23 to the contact portion 221 is between 4.17 and 4.23 mm. In the insertion direction, a distance D3 between the contact portion 221 and the slot bottom of the insertion slot 13 is not greater than 1.43 mm. In the present embodiment, the expansion length L1 of each conductive terminal 2 from the soldering portion 23 to the contact portion 221 is about 4.17 mm, and the distance D3 between the contact portion 221 and the slot bottom of the insertion slot 13 is 1.37 mm. In other embodiments, the elastic arm 22 of each conductive terminal 2 may only extend from the base 21 toward the mating surface 14. That is, the elastic arm 22 does not need to be a reversed structure, and instead extends obliquely upward. It is also possible that the contact portion 221 is not provided on the free end of the elastic arm 22.

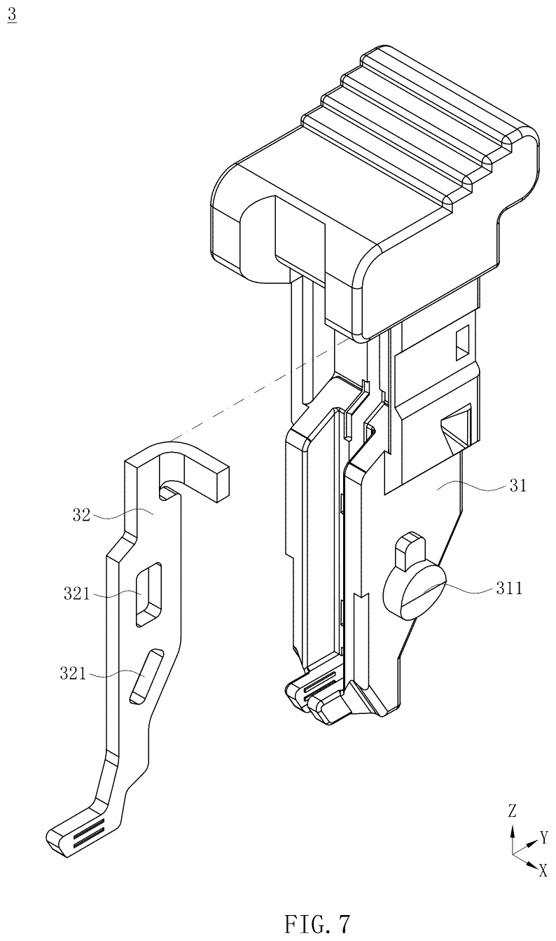

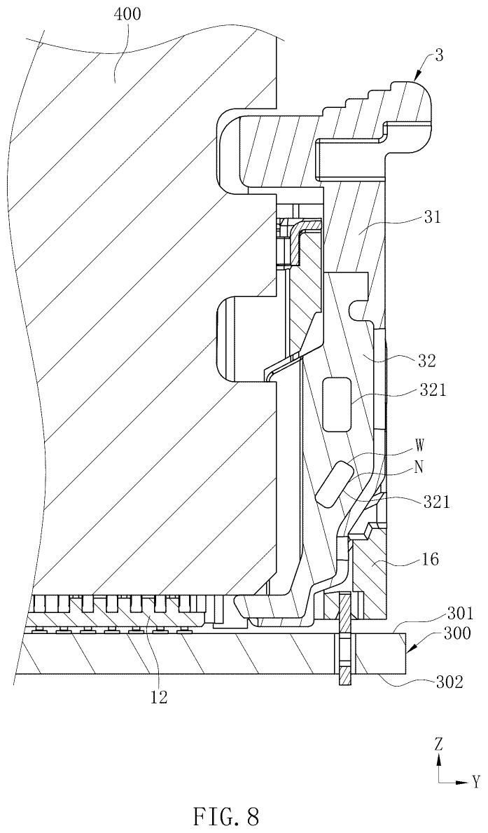

As shown in FIG. 7 and FIG. 8, the ejector 3 includes an insulation body 31 and a metal reinforcing member 32 engaged in the insulation body 31. The ejector 3 is rotatably pivoted on one of the tower portions 16 and is switched between a closed position and an open position. The ejector 3 is used to lock the electronic card 400 inserted into the insertion slot 13 at the closed position, and the ejector 3 unlocks the electronic card 400 at the open position. The insulation body 31 is provided with a rotating shaft 311 at each of two sides in the lateral direction. The rotating shaft 311 is used to be pivoted to the insulating body 1, such that the ejector 3 may rotate relative to the insulating body 1. The metal reinforcing member 32 is provided with at least one through hole 321. The through hole 321 runs through the metal reinforcing member 32 along the lateral direction, and the through hole 321 is provided for the insulation body 31 to be engaged therein. In the present embodiment, the metal reinforcing member 32 is provided with a plurality of through holes 321. Each through hole 321 has a length N and a width W. When the ejector 3 is located at the closed position, the length N of one of the through holes 321 is provided obliquely relative to the insertion direction, and the through hole 321 with its length being provided obliquely relative to the insertion direction is provided corresponding to the rotating shaft 311. In other embodiments, it is possible to provide only one through hole 321, and the through hole 321 may be in other shapes, for example, a round through hole 321.

As shown in FIG. 4, FIG. 7 and FIG. 8, the ejector 3 has a card ejecting portion 33. When the ejector 3 is at the open position, the card ejecting portion 33 abuts against the electronic card 400 inserted into the insertion slot 13. The card ejecting portion 33 has a first abutting surface 331 used to abut against the electronic card 400. In the present embodiment, the card ejecting portion 33 is formed collectively by the insulation body 31 and the metal reinforcing member 32, and the metal reinforcing member 32 partially extends to the card ejecting portion 33. In other embodiments, it is possible that only a portion of the metal reinforcing member 32 passing beyond the insulation body 31 functions as the card ejecting portion 33.

As shown in FIG. 1, FIG. 2, FIG. 3 and FIG. 6, the card edge connector 200 is a regular card edge connector 200 commonly used in the industry, which complies with the Joint Electron Device Engineering Council (JEDEC) specification. The card edge connector 200 includes an insulating seat 4, a plurality of mating terminals 5 accommodated on the insulating seat 4 and two card locking members 6 mounted at two ends of the insulating seat 4 in the longitudinal direction. Each card locking member 6 may rotate relative to the insulating seat 4. The insulating seat 4 includes two side portions 41 extending along the longitudinal direction and opposite to each other in the lateral direction and a bottom portion 42 connecting the two side portions 41, and defines an engaging slot 43 surroundingly formed by the two side portions 41 and the bottom portion 42. The insulating seat 4 has an insertion surface 44 and an assembly surface 45 provided opposite to each other along the insertion direction. The assembly surface 45 is provided to face the first surface 301, and the engaging slot 43 runs through the insertion surface 44 along the insertion direction. In other embodiments, the card edge connector 200 may be provided with only one card locking member 6.

As shown in FIG. 1 and FIG. 8, the card locking member 6 has a card pushing portion 61. The card locking member 6 may be switched between a closed position and an open position. The card locking member 6, at the closed position, is used to lock the electronic card 400 inserted into the engaging slot 43. When the card locking member 6 is at the open position, the card pushing portion 61 abuts against the electronic card 400 inserted into the engaging slot 43. The card pushing portion 61 has a second abutting surface 611 used to abut against the electronic card 400.

As shown in FIG. 2, FIG. 3 and FIG. 6, each mating terminal 5 includes a body portion 51, a spring arm 52 and a soldering leg 53. The body portion 51 is provided on the insulating seat 4. The spring arm 52 is formed by extending from the body portion 51 and has a conductive portion 521. The conductive portion 521 is exposed to the engaging slot 43 in the lateral direction. The soldering leg 53 is exposed to the assembly surface 45 and is soldered to the circuit board 300. According to the JEDEC specification, a distance between a slot bottom of the engaging slot 43 and the assembly surface 45 in the insertion direction is about 2 mm, or very close to 2 mm. An expansion length L2 of each mating terminal 5 of the regular card edge connector 200 commonly used in the industry is about 6.75 mm, and L2>L1. A distance D4 between the conductive portion 521 of each mating terminal 5 of the regular card edge connector 200 commonly used in the industry and the slot bottom of the engaging slot 43 in the insertion direction is about 2.3 mm, and D4>D3. Each mating terminal 5 is an integral structure formed by punching a metal plate, and a thickness of the metal plate forming the conductive terminals 2 is thinner than a thickness of the metal plate forming the mating terminals 5. In other embodiments, the soldering portion 23 of each conductive terminal 2 and the soldering leg 53 of each mating terminal 5 may both be through hole type pins that are inserted in the through holes of the circuit board 300. Alternatively, the conductive terminals 2 and the mating terminals 5 may all be provided with pressing type pins (that is, the fisheye structure pins), which are inserted into the through holes of the circuit board 300 by pressing.

As shown in FIG. 2, FIG. 3 and FIG. 8, in the insertion direction, a distance H1 between the slot bottom of the insertion slot 13 and the mounting surface 15 is less than a distance between a slot bottom of the engaging slot 43 and the assembly surface 45. The insertion slot connector 100 and the card edge connector 200 are both mounted on the first surface 301 of the circuit board 300. In the insertion direction, a distance D5 between the slot bottom of the insertion slot 13 and the first surface 301 is less than a distance D6 between the slot bottom of the engaging slot 43 and the first surface 301, and a distance D7 between the contact portion 221 and the first surface 301 is less than a distance D8 between the conductive portion 521 and the first surface 301. In the insertion direction, a distance between the mating surface 14 and the circuit board 300 is less than a distance between the insertion surface 44 and the circuit board 300. When the ejector 3 is at the closed position and the card locking member 6 is at the closed position, a distance between the first abutting surface 331 and the circuit board 300 is less than a distance between the second abutting surface 611 and the circuit board 300.

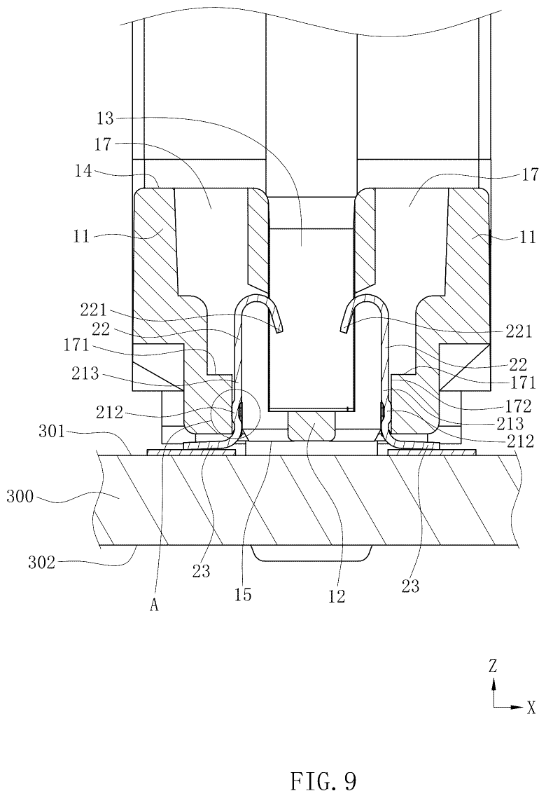

FIG. 9 to FIG. 11 show a connector assembly 1000 according to a second embodiment of the present invention, in which the card edge connector 200 is identical, and is thus not further described or illustrated in the drawings. For the insertion slot connector 100, the structure of the insulating body 1 is almost identical to that in the first embodiment, and for the conductive terminals 2, except that the base 21 is different from that in the first embodiment, other structures of each conductive terminal 2 are identical to those of each conductive terminal 2 in the first embodiment, and may be referenced to the description in the first embodiment without being hereinafter elaborated. The base 21 is protrudingly provided with at least one fixing portion 212 on one of the plate surfaces 211 located farther away from the insertion slot 13 in the lateral direction. In the present embodiment, a fixing portion 212 is provided at each of two ends of the corresponding plate surface 211 along the longitudinal direction. Each fixing portion 212 abuts against the matching slot wall 172 in the lateral direction. The base 21 has a movable portion 213 located closer to the mating surface 14 than the fixing portions 212 in the insertion direction. The movable portion 213 is connected to the elastic arm 22. A gap S exists between the movable portion 213 and the matching slot wall 172 due to existence of the fixing portions 212 for the movable portion 213 to deviate. Thus, when each conductive terminal 2 is in elastic contact with the electronic card 400, an elastic deformable region of the conductive terminal 2 becomes longer, facilitating better elastic characteristics on the condition that the overall length of each conductive terminal 2 is less than the overall length of each mating terminal 5 of the regular card edge connector 200.

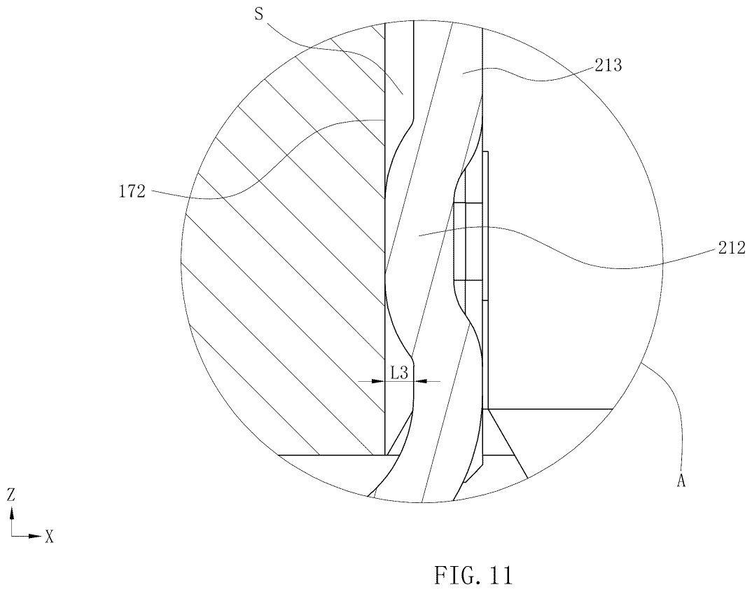

As shown in FIG. 11, in the present embodiment, a length L3 of each fixing portion 212 protruding in the lateral direction relative to the corresponding plate surface 211 on which the fixing portion 212 is provided is 0.05 mm. In other embodiments, the length L3 of each fixing portion 212 protruding in the lateral direction relative to the corresponding plate surface 211 on which the fixing portion 212 is provided may be adjusted according to actual needs, as long as the length L3 is less than 0.05 mm.

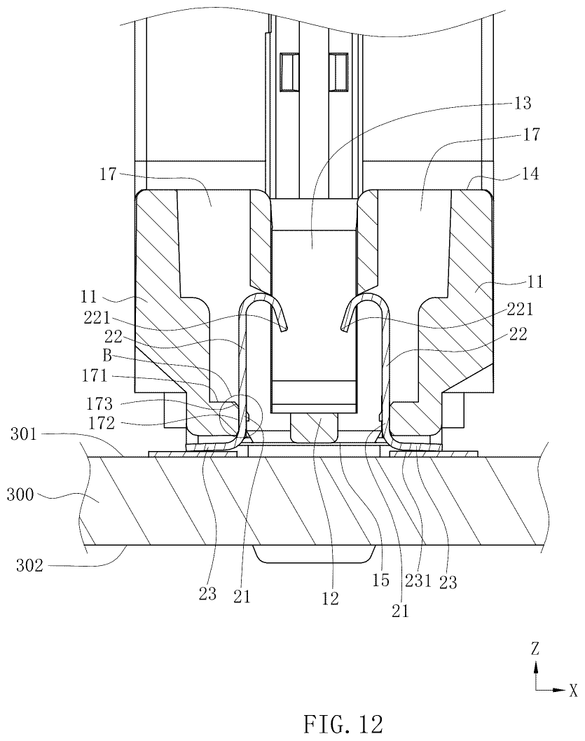

FIG. 12 to FIG. 15 show a connector assembly 1000 according to a third embodiment of the present invention, in which the card edge connector 200 is identical, and is thus not further described or illustrated in the drawings. For the insertion slot connector 100, the insulating body 1 may be matched with the conductive terminals 2 in the first embodiment and the second embodiment. For the insulating body 1 in the present embodiment, except that the structure of each terminal slot 17 is different from that in the first embodiment, other structures of the insulating body 1 are identical to those in the first embodiment, and may be referenced to the description in the first embodiment without being hereinafter elaborated. Each terminal slot 17 further has a position limiting surface 173 connected to the matching slot wall 172 and the step surface 171. The position limiting surface 173 is formed by extending from the matching slot wall 172 toward one side away from the insertion slot 13 in the lateral direction and toward the step surface 171 in the insertion direction. The position limiting surface 173 may be formed by an oblique surface, or may be formed by a plurality of surfaces extending in different oblique angles. The position limiting surface 173 limits the movable portion 213 of the base 21 located between the elastic arm 22 and the fixing portion 212 in the insertion direction from excessive rotating, and provides support in the elastic deforming process of the elastic arm 22 and the movable portion 213, thus resolving the issue of stress concentration in the elastic deforming process of the conductive terminals 2. A gap S is formed between the position limiting surface 173 and the base 21 in the lateral direction, and the gap S gradually becomes larger along a direction from the mounting surface 15 toward the mating surface 14.

In sum, the insertion slot connector and the connector assembly according to certain embodiments of the present invention have the following beneficial effects:
(1) By extending the elastic arm 22 of each conductive terminal 2 toward the mating surface 14 along the insertion direction and turning back to extend toward the bottom wall 12, the contact portion 221 is provided at the free end of the elastic arm 22, and the distance between the slot bottom of the insertion slot 13 and the soldering surface 231 in the insertion direction is not greater than 0.70 mm. Thus, on the premise of ensuring the mechanical characteristics of the conductive terminals 2, the length of each conductive terminal 2 is reduced, and the antenna effect is reduced.
(2) The base 21 is protrudingly provided with at least one fixing portion 212 on one of the plate surfaces 211 located farther away from the insertion slot 13 in the lateral direction. Each fixing portion 212 abuts against the matching slot wall 172 in the lateral direction. The base 21 has a movable portion 213 located closer to the mating surface 14 than the fixing portions 212 in the insertion direction. The movable portion 213 is connected to the elastic arm 22. A gap S exists between the movable portion 213 and the matching slot wall 172 due to existence of the fixing portions 212 for the movable portion 213 to deviate. Thus, when each conductive terminal 2 is in clastic contact with the electronic card 400, an elastic deformable region of the conductive terminal 2 becomes longer, facilitating better elastic characteristics on the condition that the overall length of each conductive terminal 2 is less than the overall length of each mating terminal 5 of the regular card edge connector 200.
(3) Each terminal slot 17 further has a position limiting surface 173 connected to the matching slot wall 172 and the step surface 171. The position limiting surface 173 is formed by extending from the matching slot wall 172 toward one side away from the insertion slot 13 in the lateral direction and toward the step surface 171 in the insertion direction. The position limiting surface 173 limits the movable portion 213 of the base 21 located between the elastic arm 22 and the fixing portion 212 in the insertion direction from excessive rotating. That is, the position limiting surface 173 provides support in the elastic deforming process of the elastic arm 22 and the movable portion 213, thus resolving the issue of stress concentration in the elastic deforming process of the conductive terminals 2.
(4) An expansion length of each conductive terminal 2 from the soldering portion 23 to the contact portion 221 is between 4.17 and 4.23 mm, which may reduce the antenna effect generated by the conductive terminals 2 on the premise that the mechanical characteristics of the conductive terminals 2 satisfy the requirement. Thus, in the case where the card edge connector 200 has a corresponding electronic card 400 being inserted therein and the insertion slot connector 100 is without a corresponding electronic card 400 being inserted therein, the electromagnetic interference by the insertion slot connector 100 to the card edge connector 200 is reduced, thereby improving the high frequency characteristics of the connector assembly 1000.
(5) The conductive terminals 2 and the mating terminals 5 are all formed by punching metal plates, and a thickness of the metal plate forming the conductive terminals 2 is thinner than a thickness of the metal plate forming the mating terminals 5. Thus, in the case where the overall length of the conductive terminals 2 is short, a metal plate is utilized for forming to be thinner than the mating terminals 5 of the regular card edge connector 200, thereby satisfying the mechanical characteristics of the conductive terminals 2 and having better elasticity.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

1. An insertion slot connector, comprising:
an insulating body, comprising two side walls extending along a longitudinal direction and opposite to each other in a lateral direction and a bottom wall connecting the two side walls, and defining an insertion slot surroundingly formed by the two side walls and the bottom wall, wherein the insulating body has a mating surface and a mounting surface provided opposite to each other along an insertion direction, the insertion slot runs through the mating surface along the insertion direction, and each two of the longitudinal direction, the lateral direction and the insertion direction are perpendicular to each other; and
a plurality of conductive terminals, wherein each of the conductive terminals comprises a base, an elastic arm and a soldering portion, the base is provided on the insulating body, the elastic arm extends from one end of the base adjacent to the mating surface toward the mating surface and turns back to extend toward the bottom wall, the elastic arm has a free end and is provided with a contact portion on the free end, the contact portion is exposed to the insertion slot in the lateral direction, the soldering portion bends and extends from one end of the base adjacent to the mounting surface, the soldering portion has a soldering surface, and the soldering surface is exposed to the mounting surface along the insertion direction.

2. The insertion slot connector according to claim 1, wherein an expansion length of each of the conductive terminals from the soldering portion to the contact portion is between 4.17 and 4.23 mm.

3. The insertion slot connector according to claim 1, wherein a distance between the contact portion and the slot bottom of the insertion slot is not greater than 1.43 mm.

4. (canceled)

5. The insertion slot connector according to claim 1, further comprising an ejector, wherein the insulating body comprises at least one tower portion located on at least one end of the insertion slot in the longitudinal direction, the ejector is rotatably mounted on the tower portion and switched between a closed position and an open position, the ejector is configured to lock an electronic card inserted into the insertion slot at the closed position, the ejector unlocks the electronic card at the open position, the ejector comprises an insulation body and a metal reinforcing member engaged in the insulation body, the metal reinforcing member is provided with at least one through hole, the through hole runs through the metal reinforcing member along the lateral direction, the through hole is provided for the insulation body to be engaged therein, the through hole has a length and a width, and when the ejector is located at the closed position, the length is provided obliquely relative to the insertion direction.

6. The insertion slot connector according to claim 1, wherein the insulating body has a plurality of terminal slots, the conductive terminals are correspondingly accommodated in the terminal slots, each of the terminal slots and the insertion slot are in communication with each other in the lateral direction, each of the terminal slots has a step surface located farther away from the insertion slot than the base in the lateral direction, the step surface is parallel to the slot bottom of the insertion slot, in the insertion direction, the step surface is located closer to the mating surface than the slot bottom of the insertion slot, and a distance between the step surface and the slot bottom of the insertion slot in the insertion direction is not greater than one half of a height of the bottom wall in the insertion direction.

7. The insertion slot connector according to claim 1, wherein the insulating body has a plurality of terminal slots, the conductive terminals are correspondingly accommodated in the terminal slots, each of the terminal slots and the insertion slot are in communication with each other in the lateral direction, the base is provided with a fixing portion, the fixing portion interferes with a corresponding one of the terminal slots, in the insertion direction, the fixing portion is located closer to the mounting surface than the slot bottom of the insertion slot, and a distance between the fixing portion and the slot bottom of the insertion slot is not greater than one third of a height of the bottom wall in the insertion direction.

8. The insertion slot connector according to claim 1, wherein the insulating body has a plurality of terminal slots, the conductive terminals are correspondingly accommodated in the terminal slots, each of the terminal slots has a matching slot wall for the base to abut against the matching slot wall in the lateral direction, each of the conductive terminals is formed by bending a metal plate, the base has two plate surfaces opposite to each other in a thickness direction of the metal plate, the two plate surfaces are provided opposite to each other along the lateral direction, the base is protrudingly provided with at least one fixing portion on one of the plate surfaces located farther away from the insertion slot in the lateral direction, the fixing portion abuts against the matching slot wall in the lateral direction, the base portion has a movable portion located closer to the mating surface than the fixing portion in the insertion direction, the movable portion is connected to the elastic arm, and a gap exists between the movable portion and the matching slot wall due to existence of the fixing portion for the movable portion to deviate.

9. The insertion slot connector according to claim 8, wherein a length of the fixing portion protruding in the lateral direction relative to a corresponding one of the plate surfaces is not less than 0.05 mm.

10. The insertion slot connector according to claim 1, wherein the insulating body has a plurality of terminal slots, the conductive terminals are correspondingly accommodated in the terminal slots, each of the terminal slots has at least one matching slot wall for the base to abut against the matching slot wall in the lateral direction, the matching slot wall is a flat structure extending the insertion direction and the longitudinal direction, the matching slot wall is located at one side of the base away from the insertion slot in the lateral direction, the base has a movable portion connected to the elastic arm, each of the terminal slots further has a position limiting surface connected to the matching slot wall and configured to limit the movable portion from excessive rotating, and the position limiting surface is formed by extending from the matching slot wall toward one side away from the insertion slot in the lateral direction and toward the mating surface in the insertion direction.

11. The insertion slot connector according to claim 10, wherein a gap between the position limiting surface and a corresponding one of the conductive terminals gradually becomes larger along a direction from the mounting surface toward the mating surface.

12. A connector assembly, comprising:
a circuit board, having a first surface and a second surface provided opposite to each other in an insertion direction; and
at least one insertion slot connector and at least one card edge connector, wherein the at least one insertion slot connector and the at least one card edge connector are alternately mounted on the circuit board along a lateral direction, and the lateral direction is perpendicular to the insertion direction;
wherein the insertion slot connector comprises an insulating body and a plurality of conductive terminals provided on the insulating body, the insulating body comprises two side walls extending along a longitudinal direction and opposite to each other in the lateral direction and a bottom wall connecting the two side walls, and defines an insertion slot surroundingly formed by the two side walls and the bottom wall, the longitudinal direction is perpendicular to the lateral direction and the insertion direction, the insulating body has a mating surface and a mounting surface provided opposite to each other along the insertion direction, the mounting surface is provided to face the first surface in the insertion direction, the insertion slot runs through the mating surface along the insertion direction, each of the conductive terminals comprises a base, an elastic arm and a soldering portion, the base is provided on the insulating body, the elastic arm extends from one end of the base adjacent to the mating surface toward the mating surface and turns back to extend toward the bottom wall, the elastic arm has a free end and is provided with a contact portion on the free end, the contact portion is exposed to the insertion slot in the lateral direction, and the soldering portion is exposed to the mounting surface and is soldered to the circuit board;
wherein the card edge connector comprises an insulating seat and a plurality of mating terminals accommodated in the insulating seat, the insulating seat comprises two side portions extending along the longitudinal direction and opposite to each other in the lateral direction and a bottom portion connecting the two side portions, and defines an engaging slot surroundingly formed by the two side portions and the bottom portion, the insulating seat has an insertion surface and an assembly surface provided opposite to each other along the insertion direction, the assembly surface is provided to face the first surface, the engaging slot runs through the insertion surface along the insertion direction, each of the mating terminals comprises a body portion, a spring arm and a soldering leg, the body portion is provided on the insulating seat, the spring arm is formed by extending from the body portion and has a conductive portion, the conductive portion is exposed to the engaging slot in the lateral direction, and the soldering leg is exposed to the mounting surface and is soldered to the circuit board;
wherein in the insertion direction, a distance between the insertion slot and the first surface is less than a distance between the engaging slot and the first surface, a distance between the contact portion and the first surface is less than a distance between the conductive portion and the first surface, and a distance between the contact portion and a slot bottom of the insertion slot is less than a distance between the conductive portion and a slot bottom of the engaging slot.

13. The connector assembly according to claim 12, wherein a distance between the insertion slot and the first surface in the insertion direction is not greater than 0.70 mm.

14. The connector assembly according to claim 12, wherein an expansion length of each of the conductive terminals from the soldering portion to the contact portion is not greater than an expansion length of each of the mating terminals from the soldering leg to a tail end of the spring arm.

15. The connector assembly according to claim 12, wherein an expansion length of each of the conductive terminals from the soldering portion to the contact portion is between 4.17 and 4.23 mm.

16. The connector assembly according to claim 12, wherein each of the conductive terminals is formed by bending a metal plate, the contact portion is provided with at least one chamfer structure along at least one of a thickness direction and a width direction of the metal plate, and the chamfer structure of the contact portion formed in the thickness direction is exposed to the insertion slot in the lateral direction to be in contact with an electronic card inserted into the insertion slot.

17. A connector assembly, comprising:
a circuit board; and
at least one insertion slot connector and at least one card edge connector, wherein the at least one insertion slot connector and the at least one card edge connector are alternately mounted on the circuit board along a lateral direction;
wherein the insertion slot connector has an insertion slot, the card edge connector has an engaging slot, the insertion slot and the engaging slot are configured for insertion of an electronic card of a same type along an insertion direction, the insertion direction is perpendicular to the lateral direction, and in the insertion direction, a distance between a slot bottom of the insertion slot and the circuit board is less than a distance between a slot bottom of the engaging slot and the circuit board.

18. The connector assembly according to claim 17, wherein:
the insertion slot connector comprises an insulating body and a plurality of conductive terminals provided on the insulating body, the insulating body has a mating surface and a mounting surface provided opposite to each other along the insertion direction and the insertion slot formed by recessing from the mating surface toward the mounting surface, and the mounting surface is provided to face the circuit board; and
the card edge connector comprises an insulating seat and a plurality of mating terminals provided on the insulating seat, the insulating seat has an mating surface and an assembly surface provided opposite to each other along the insertion direction and the engaging slot formed by recessing from the mating surface toward the assembly surface, the assembly surface is provided to face the circuit board, and in the insertion direction, a distance between the mating surface and the circuit board is less than a distance between the insertion surface and the circuit board.

19. The connector assembly according to claim 18, wherein:
the insertion slot connector further comprises an ejector, the ejector comprises an insulating main body and a metal reinforcing member provided on the insulating main body, the ejector has a card ejecting portion, the metal reinforcing member partially extends to the card ejecting portion, the ejector is rotatably mounted on one end of the insulating body in a longitudinal direction, the longitudinal direction is perpendicular to the insertion direction and the lateral direction, the ejector is switched between a closed position and an open position, the ejector is configured to lock the electronic card inserted into the insertion slot at the closed position, and when the ejector is at the open position, the card ejecting portion abuts against the electronic card inserted into the insertion slot; and
the card edge connector further comprises a card locking member, the card locking member has a card pushing portion, the card locking member is rotatably mounted on at least one end of the insulating seat in the longitudinal direction, the card locking member is switched between a closed position and an open position, the card locking member is configured to lock the electronic card inserted into the engaging slot at the closed position, when the card locking member is at the open position, the card pushing portion abuts against the electronic card inserted into the insertion slot, the card ejecting portion has a first abutting surface configured to abut against the electronic card, the card pushing portion has a second abutting surface configured to abut against the electronic card, and when the ejector is at the closed position and the card locking member is at the closed position, a distance between the first abutting surface and the circuit board is less than a distance between the second abutting surface and the circuit board.

20. The connector assembly according to claim 18, wherein:
each of the conductive terminals is an integral structure and comprises a base and an elastic arm, the elastic arm extends from one end of the base, and the elastic arm is provided with a contact portion exposed to the insertion slot; and
each of the mating terminals comprises a body portion and a spring arm, the spring arm is formed by extending from the body portion and has a conductive portion exposed to the engaging slot, and in the insertion direction, a distance between the contact portion and the circuit board is less than a distance between the conductive portion and the circuit board.

21. The connector assembly according to claim 20, wherein the conductive terminals are formed by punching a metal plate, the mating terminals are formed by punching a different metal plate, and a thickness of the metal plate forming the conductive terminals is thinner than a thickness of the metal plate forming the mating terminals.

22. The insertion slot connector according to claim 1, wherein a distance between a slot bottom of the insertion slot and the soldering surface in the insertion direction is not greater than 0.70 mm.
